(19) United States
(12) Patent Application Publication
(10) Pub. No.: US 2005/0236889 A1
(43) Pub. Date: Oct. 27, 2005

(54) Hydraulic braking pressure generating apparatus for vehicles

(76) Inventor: Akihito Kusano, Toyota city (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 11/110,878

(22) Filed: Apr. 21, 2005

(30) Foreign Application Priority Data
Apr. 27, 2004 (JP) 2004-131800
Apr. 27, 2004 (JP) 2004-131802

(51) Int. Cl. B60T 8/34

(52) U.S. Cl. 303/113.4; 303/113.1

(57) ABSTRACT

A pressure generating apparatus includes a master cylinder, a stroke simulator and a communication control device, which includes a seal member disposed in a cylinder housing, and a communication passage formed on a part of outer periphery of a second master piston. When the second master piston is placed in the initial position thereof, a first master chamber is communicated with the stroke simulator through the communication passage. When the second master piston is advanced from the initial position by the predetermined distance or more, the communication passage is separated from the first master chamber by the seal member, to block the communication between the first master chamber and the stroke simulator.

This application claims priorities under 35 U.S.C. Sec. 119 to Nos. 2004-131800 and 2004-131802 filed in Japan on Apr. 27, 2004, the entire contents of which are herein incorporated by reference.

### BACKGROUND OF THE INVENTION

1. Field of the invention

The present invention relates to a hydraulic braking pressure generating apparatus for vehicles, and more particularly, the hydraulic braking pressure generating apparatus provided with a braking stroke simulator.

2. Description of the Related Arts

Heretofore, there are known various hydraulic braking pressure generating apparatuses for vehicles, which are provided with braking stroke simulators. In general, hydraulic pressure generated by a pressure source is controlled by a pressure control device including the pressure source in response to operation of a manually operated braking member, to be supplied into wheel brake cylinders, with the communication between a master cylinder and wheel brake cylinders being blocked. When the pressure control device has come to be abnormal, the master cylinder is communicated with the wheel brake cylinder, to discharge the hydraulic pressure into the wheel brake cylinders in response to braking operation force of the manually operated braking member.

Also, there has been known heretofore an apparatus, wherein a first piston member is accommodated in a cylinder housing to be moved back and forth in response to operation of a manually operated braking member, and a second piston member is slidably accommodated in the cylinder housing for defining a first master pressure chamber between the first piston member and the second piston member, and defining a second master pressure chamber between the second piston member and the cylinder housing, and wherein a stroke simulator is communicated with the first master pressure chamber for absorbing brake fluid of an amount determined in response to the hydraulic pressure discharged from the first master pressure chamber, to provide a stroke for the first piston member in response to braking operation force of the manually operated braking member. And, a communication control device is provided for communicating the first master pressure chamber with the stroke simulator when the second piston member is placed in an initial position thereof, and blocking the communication between the first master pressure chamber and the stroke simulator, when the second piston member is advanced by a predetermined distance or more from the initial position thereof.

As for the communication control device, a secondary piston provided with a sealing element is disclosed in Japanese Patent Laid-open publication (PCT) 2001-526150, which corresponds to the U.S. Pat. No. 6,192,685B1, for example, wherein the sealing element is mounted on a land portion of the secondary piston, and a peripheral groove is formed to be associated with the sealing element in a bore of a housing. Also, according to a master cylinder as disclosed in European Patent No. 1291257A1, a seal member disposed in a cylinder housing has been employed to shut off the communication between the first master pressure chamber and the stroke simulator.

However, if the secondary piston provided with the sealing element is employed in the communication control device, as disclosed in the U.S. Pat. No. 6,192,685B1, after the communication between the first master pressure chamber and the stroke simulator was blocked, the sealing element has to slide in the cylinder housing. Therefore, a high accuracy is required for working the cylinder housing, when the inner peripheral surface thereof is formed.

According to the sealing element or seal member disposed in the cylinder housing to be employed in the communication control device, as disclosed in the European Patent No. 1291257A1, after the communication between the first master pressure chamber and the stroke simulator was blocked, the secondary piston has to slide in the sealing element. Therefore, a high accuracy is required, when the outer peripheral surface of the secondary piston is formed. Comparing this working process with that as required for forming the inner peripheral surface of the cylinder housing as described above, the working can be made easily, and the master cylinder can be produced at a lower cost. However, as an annular groove formed along the whole periphery of the secondary piston has been employed as a communication passage, the sealing element might be removed from the groove inward of the inner peripheral surface, depending upon material of the sealing element, further improvement is required for ensuring a reliability for an inexpensive apparatus.

With respect to the apparatus as described above, also has been known the apparatus provided with the communication control device having a sealing element disposed in the cylinder housing and applied with the hydraulic pressure in the first master pressure chamber when the first master pressure chamber is communicated with the stroke simulator. As for the communication control device, a third valve unit is disclosed in an actuator for use in an electro-hydraulic braking system as described in German Patent Publication NO. DE10119128A1, for example, which discloses the third valve unit including a packing sleeve, which corresponds to the sealing element, and a pressure-connecting portion, which corresponds to the communication passage for communicating the first master pressure chamber with the stroke simulator. It is presumed that the communication between the first master pressure chamber and the stroke simulator is blocked by the third valve unit in response to operation of the master piston.

According to the sealing element or seal member disposed in the cylinder housing to be employed in the communication control device, as disclosed in the German Patent Publication NO. DE10119128A1, after the communication between the first master pressure chamber and the stroke simulator was blocked, the sealing element has to slide in the cylinder housing. Therefore, a high accuracy is required, when the inner peripheral surface of the cylinder housing is formed.

### SUMMARY OF THE INVENTION

Accordingly, it is an object of the present invention to provide a hydraulic braking pressure generating apparatus for vehicles, which is provided with a master cylinder and a braking stroke simulator, together with a pressure control device having a high reliability, and which can be produced at a low cost.

In order to accomplish the above and other objects, the hydraulic braking pressure generating apparatus is provided with a first piston member which is slidably accommodated in a cylinder housing to be moved back and forth in response to operation of a manually operated braking member, a second piston member which is slidably accommodated in the cylinder housing for defining a first master pressure chamber between the first piston member and the second piston member, and defining a second master pressure chamber between the second piston member and the cylinder housing, and a stroke simulator which is communicated with the first master pressure chamber for absorbing brake fluid of an amount determined in response to the hydraulic pressure discharged from the first master pressure chamber, to provide a stroke for the first piston member in response to braking operation force of the manually operated braking member. The apparatus is further provided with a communication control device which communicates the first master pressure chamber with the stroke simulator when the second piston member is placed in an initial position thereof, and blocks the communication between the first master pressure chamber and the stroke simulator, when the second piston member is advanced by a predetermined distance or more from the initial position thereof. The communication control device includes a seal member which is disposed in the cylinder housing, and a communication passage which is formed on a part of outer periphery of the second piston member. The communication control device communicates the first master pressure chamber with the stroke simulator through the communication passage, when the second piston member is placed in the initial position thereof, and separates the communication passage from the first master pressure chamber by the seal member, when the second piston member is advanced from the initial position thereof by the predetermined distance or more, to block the communication between the first master pressure chamber and the stroke simulator.

In the apparatuses as described above, preferably, the communication passage includes a longitudinal communication groove, which is formed around a part of the outer peripheral surface of the second piston member. Or, the communication passage may include a longitudinal cut-out section, which is formed around a part of the outer peripheral surface of the second piston member. Or, the communication passage may include a communication hole, which is formed to penetrate the second piston member in a direction crossing a longitudinal axis thereof.

Furthermore, the apparatus may be provided with a communication control device having a seal member, which is disposed in the cylinder housing, and which is applied with the hydraulic pressure in the first master pressure chamber when the first master pressure chamber is communicated with the stroke simulator. According to this apparatus, the communication control device communicates the first master pressure chamber with the stroke simulator when the second piston member is placed in an initial position thereof, and blocks the communication between the first master pressure chamber and the stroke simulator, by the seal member, when the second piston member is advanced by a predetermined distance or more from the initial position thereof. The communication control device includes a communication hole which is formed to penetrate the second piston member in a direction crossing a longitudinal axis thereof. And, the communication control device communicates the first master pressure chamber with the stroke simulator through the communication hole, when the second piston member is placed in the initial position thereof, and separates the communication hole from the first master pressure chamber by the seal member, when the second piston member is advanced from the initial position thereof by the predetermined distance or more, to block the communication between the first master pressure chamber and the stroke simulator.

In the apparatuses as described above, the stroke simulator may be accommodated in the second piston member.

### BRIEF DESCRIPTION OF THE DRAWINGS

The above stated object and following description will become readily apparent with reference to the accompanying drawings, wherein like reference numerals denote like elements, and in which:

FIG. 1 is a sectional view of a hydraulic braking pressure generating apparatus for vehicles according to an embodiment of the present invention;

FIG. 2 is a schematic block diagram of a hydraulic brake apparatus having a hydraulic braking pressure generating apparatus according to an embodiment of the present invention;

FIG. 3 is a sectional view of a master piston, with its main body portion sectioned in a direction perpendicular to its longitudinal axis according to the embodiment as shown in FIG. 1;

FIG. 4 is a sectional view of another master piston, with its main body portion sectioned in a direction perpendicular to its longitudinal axis according to the embodiment as shown in FIG. 1;

FIG. 5 is a sectional view of a hydraulic braking pressure generating apparatus for vehicles according to another embodiment of the present invention;

FIG. 6 is a sectional view of a hydraulic braking pressure generating apparatus for vehicles according to a further embodiment of the present invention;

FIG. 7 is a sectional view of a hydraulic braking pressure generating apparatus for vehicles according to a yet further embodiment of the present invention;

FIG. 8 is a sectional view of another master piston sectioned along its longitudinal axis according to the embodiment as shown in FIG. 7;

FIG. 9 is a schematic block diagram of a hydraulic brake apparatus having a hydraulic braking pressure generating apparatus according to the embodiment as shown in FIG. 7; and

FIG. 10 is a sectional view of a hydraulic braking pressure generating apparatus for vehicles according to a yet further embodiment of the present invention.

### DESCRIPTION OF THE PREFERRED EMBODIMENTS

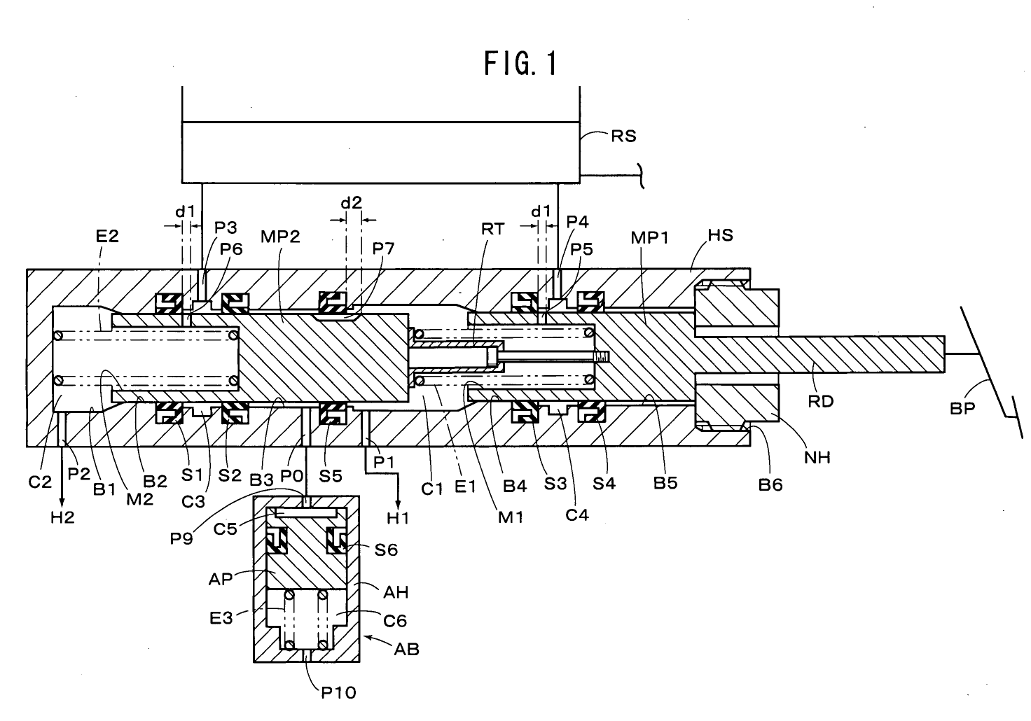

Referring to FIG. 1, there is illustrated a hydraulic braking pressure generating apparatus according to an embodiment of the present invention, wherein a first master piston MP1 served as the first piston member is slidably accommodated in a cylinder housing HS (hereinafter, simply referred to as housing HS), and connected to a brake pedal BP served as the manually operated braking member. Also, a second master piston MP2 served as the second piston member is slidably accommodated in the housing HS, so that a first master chamber C1 is defined between the first master piston MP1 and the second master piston MP2, and a second master chamber C2 is defined between the second master piston MP2 and a front end of the housing HS. To be communicated with the first master chamber C1, there is provided a stroke simulator AB, which is adapted to absorb brake fluid of the amount determined in response to the hydraulic pressure discharged from the first master chamber C1, and which provides a stroke of the first master piston MP1 in response to braking operation force of the brake pedal BP.

The housing HS is closed in its front end (left in FIG. 1) to be formed in a cylinder with a bottom, and formed with a cylinder bore having a recess B1, and a stepped bore of a small diameter bore B2, a large diameter bore B3, a small diameter bore B4 and a large diameter bore B5. At the rear end of the housing HS, there is formed an open end portion B6 with threaded grooves formed on its inner surface. On the inner wall of the cylinder bore, formed are annular grooves for holding annular seal members S1-S5 having a cup-like cross section, respectively. An atmospheric pressure chamber C3 is defined between the annular seal members S1 and S2, and an atmospheric pressure chamber C4 is defined between the annular seal members S3 and S4. The housing HS may be made of a single metallic member, because those annular grooves and the large diameter bore B3 or the like can be formed by boring the housing HS along the longitudinal axis thereof. On the side wall of the housing. HS, there are formed ports P0 and P1 opening into a front section and a rear section of the seal member S5 in the large diameter bore B3, respectively, a port P2 opening into the second master chamber C2 in the recess B1, a port P3 opening into the atmospheric pressure chamber C3, and a port P4 opening into the atmospheric pressure chamber C4. The ports P3 and P4 are communicated with an atmospheric pressure reservoir RS (hereinafter, simply referred to as reservoir RS).

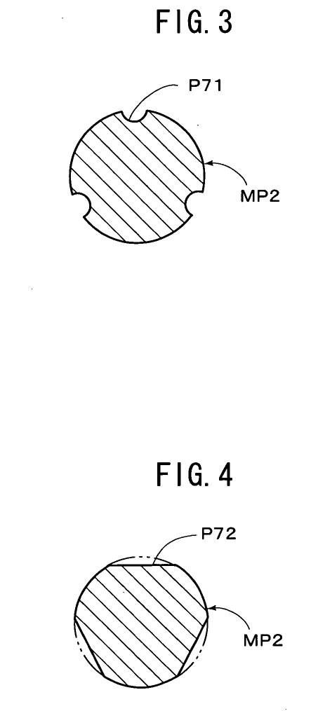

As for the first master piston MP1, there are formed at its front end a recess M1 opening forward, and formed at its rear end a rod RD extending backward. On the side wall of the first master piston MP1, there is formed a port P5 opening into the recess M1. The second master piston MP2 is formed with a recess M2 opening forward, and formed with a communication passage P7 on a part of the outer peripheral surface of its main body portion. As for the communication passage P7, longitudinal communication grooves P71 may be formed as shown in FIG. 3, around a part of the outer peripheral surface of the second master piston MP2. Or, longitudinal cut-out sections P72 may be formed as shown in FIG. 4, around a part of the outer peripheral surface (as indicated by two-dotted chain line in FIG. 4) of the second master piston MP2 to be cut out longitudinally. As shown in FIG. 1, on the side wall of the second master piston MP2, there is formed a port P6 opening into the recess M2. Between the first and second master pistons MP1 and MP2, a compression spring E1 is mounted through a retainer RT to act as a return spring, and a compression spring E2 is accommodated in the recess M2 to act as a return spring, as well.

According to the present embodiment, there is provided a stroke simulator AB, which absorbs brake fluid of the amount determined in response to the hydraulic pressure discharged from the first master chamber C1, and provides a stroke of the first master piston MP1 in response to braking operation force of the brake pedal BP. And, an operative state of the stroke simulator AB or an inoperative state thereof is selectively provided, by means of the seal member S5, which is disposed in the large diameter bore B3 of the housing HS, and the communication passage P7, which is formed on the position to be faced with the seal member S5 when the second master piston MP2 is placed in its initial position.

The stroke simulator AB includes a cylindrical housing AH, and a piston member AP fluid-tightly and slidably received therein through a seal member S6, to define a hydraulic pressure chamber C5 and atmospheric pressure chamber C6. The stroke simulator AB is so constituted that the piston member AP is urged by a compression spring E3 accommodated in the atmospheric pressure chamber C6, so as to reduce a volume of the hydraulic pressure chamber C5. Furthermore, the housing AH is formed with a port P9 for communicating the hydraulic pressure chamber C5 with an annular space between the seal members S2 and S5 through the port P0, and formed with a port P10 for opening the atmospheric pressure chamber C6 to the atmosphere.

Next will be explained the parts of the master cylinder as described above, according to an example of a sequence of steps for assembling them. At the outset, the annular seal members S1-S5 are held in the annular grooves of the housing HS. Next, the compression spring E2 is received in the recess B1 of the housing HS and the recess M2 of the second master piston MP2. Then, the second master piston MP2 with the seal members S1 and S2 mounted thereon is fluid-tightly and slidably received into the cylinder bore to define the second master chamber C2 in front of the second master piston MP2. With the compression spring E1 mounted through the retainer RT in the recess M1, the first master piston MP1 is fluid-tightly and slidably fitted into the cylinder bore through the seal members S3 and S4, to define the first master chamber C1 between the first and second master pistons MP1 and MP2. With the first and second master pistons MP1 and MP2 accommodated in the cylinder bore of the hosing HS, screwed into the open end portion B6 is a nut-like stopper NH with threaded grooves formed on its outer peripheral surface, to prevent the first and second master pistons MP1 and MP2 from being moved rearward by the biasing force of the compression spring E2.

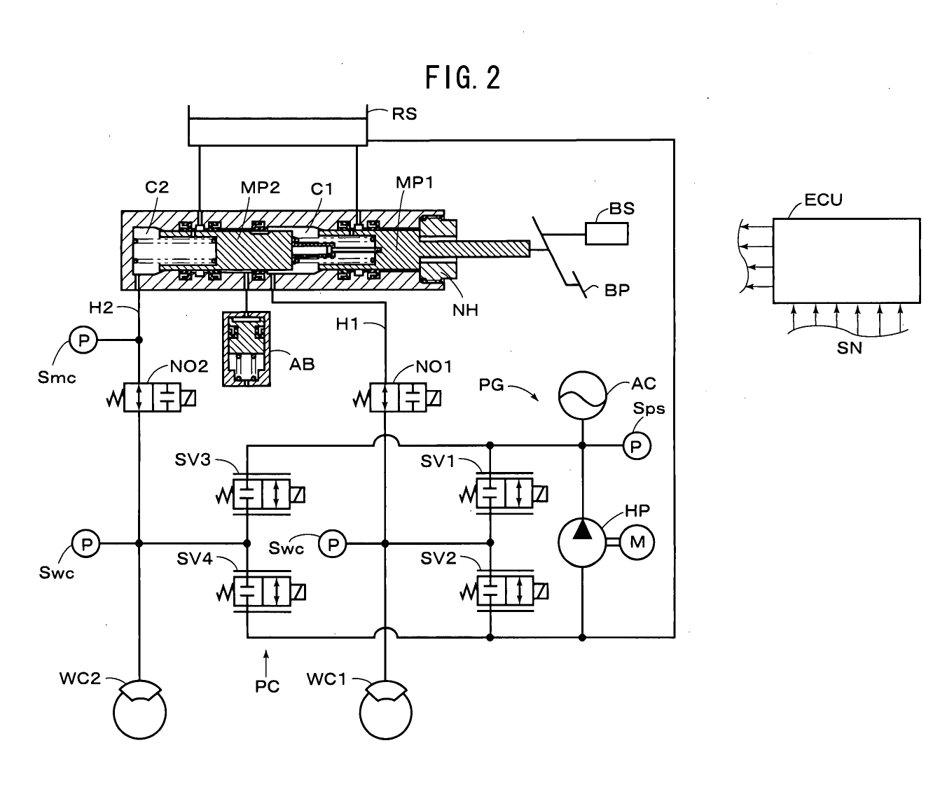

With those parts assembled as described above, the first master chamber C1 and the second master chamber C2 are defined in front of the first master piston MP1 and second master piston MP2, respectively, in the housing HS, to be communicated with the wheel brake cylinder WC1 and WC2 as shown in FIG. 2, through the ports P1 and P2 via hydraulic pressure circuits H1 and H2, respectively. When the first and second master pistons MP1 and MP2 are placed in their initial positions as shown in FIG. 1, the first and second master chambers C1 and C2 are communicated with the atmospheric pressure chambers C4 and C3, and finally communicated with the reservoir RS through the ports P4 and P3. And, when the second master piston MP2 is placed in its initial position as shown in FIG. 1, the seal member S5 is in contact with the outer peripheral surface of the other part of the peripheral surface of the main body portion, with the communication passage P7 (the communication grooves P71 in FIG. 3, or cut-out sections P72 in FIG. 4) formed on a specific one part of it, so that the first master chamber C1 under the atmospheric pressure is communicated with the hydraulic pressure chamber C5 of the stroke simulator AB through the communication passage P7 (and, the ports P0 and P9). And, when the second master piston MP2 is advanced from its initial position by a first stroke d1 (port idle) or more, the opening area of the port P6 is closed by the seal member S1, thereby to block the communication between the second master chamber C2 and the atmospheric pressure chamber C3. Likewise, when the first master piston MP1 is advanced from its initial position by the first stroke d1 (port idle) or more, the opening area of the port P5 is closed by the seal member S3, thereby to block the communication between the first master chamber C1 and the atmospheric pressure chamber C4.

With the first master piston MP1 being advanced, the piston member AP is pushed against the biasing force of the compression spring E3 to expand the pressure chamber CS, a stroke is given to the first master piston MP1. Thereafter, the pressure chamber C5 will be communicated with the first master chamber C1 through the communication passage P7 (and, the ports P0 and P9), to actuate the stroke simulator AB, until the second master piston MP2 will be advanced from its initial position by a predetermined distance (second stroke d2) to contact the seal member S5 at its whole outer peripheral surface. And, when the second master piston MP2 is advanced from its initial position by the second stroke d2 or more, the communication passage P7 is separated from the first master chamber C1 by the seal member S5, whereby the communication between the first master chamber C1 and the pressure chamber C5 is blocked. Therefore, the communication control device according to the present invention is constituted by the communication passage P7 as shown in FIG. 1 and the seal member S5, e.g., the communication grooves P71 as shown in FIG. 3 and the seal member S5, or the cut-out sections P72 as shown in FIG. 4 and the seal member S5.

The hydraulic braking pressure generating apparatus as described above is provided to constitute a hydraulic brake apparatus for a vehicle as shown in FIG. 2, wherein a normally open electromagnetic switching valve NO1 is disposed in the hydraulic pressure circuit Hi, so that the apparatus is connected to a wheel brake cylinder (indicated by WC1) in one circuit through the switching valve NO1, and it is also connected to a pressure source PG for generating a certain hydraulic pressure irrespective of the braking operation of the vehicle driver. Likewise, a normally open electromagnetic switching valve NO2 is disposed in the hydraulic pressure circuit H2, so that the apparatus is connected to a wheel brake cylinder (indicated by WC2) in the other one circuit through the switching valve NO2, and it is also connected to the pressure source PG. The pressure source PG includes an electric motor M controlled by an electronic control unit ECU, and a hydraulic pressure pump HP, which is driven by the electric motor M, and whose inlet is connected to the reservoir RS, and whose outlet is connected to an accumulator AC. According to the present embodiment, a pressure sensor Sps is connected to the outlet, and the detected pressure is monitored by the electronic control unit ECU. On the basis of the monitored result, the motor M is controlled by the electronic control unit ECU to keep the hydraulic pressure in the accumulator AC between predetermined upper and lower limits.

The accumulator AC is connected to a hydraulic passage between the switching valve NO1 and the wheel brake cylinder WC1 in the hydraulic pressure circuit Hi, through a first linear solenoid valve SV1 of a normally closed type, to regulate the hydraulic pressure discharged from the pressure source PG and supply it to the wheel brake cylinder WC1. Also, the reservoir RS is connected to the hydraulic passage between the switching valve NO1 and wheel brake cylinder WC1, through a second linear solenoid valve SV2 of a normally closed type, to reduce the pressure in the wheel brake cylinder WC1 and regulate it. Likewise, in the hydraulic pressure circuit H2, the accumulator AC is connected to a hydraulic passage between the switching valve NO2 and the wheel brake cylinder WC2, through a first linear solenoid valve SV3 of a normally closed type, to regulate the hydraulic pressure discharged from the pressure source PG and supply it to the wheel brake cylinder WC2. Also, the reservoir RS is connected to the hydraulic passage between the switching valve NO2 and wheel brake cylinder WC2, through a second linear solenoid valve SV4 of a normally closed type, to reduce the pressure in the wheel brake cylinder WC2 and regulate it. According to the present embodiment, therefore, the pressure control device PC is formed by the pressure source PG, first linear solenoid valves SV1 and SV3, second linear solenoid valves SV2 and SV4, electronic control unit ECU, and sensors as described hereinafter.

According to the present embodiment, the pressure sensor Smc is disposed at the upstream of the switching valve NO2, in the hydraulic pressure circuit H2, for example, and the pressure sensor Swc is disposed at the downstream thereof and at the downstream of the switching valve NO1 in the hydraulic pressure circuit H1. On the brake pedal BP, the stroke sensor BS is operatively connected to detect its stroke. The signals detected by the sensors as described above are fed to the electronic control unit ECU. Thus, the hydraulic braking pressure discharged from the master chamber C2, the hydraulic braking pressure in the wheel brake cylinders WC2 and WC1, and the stroke of the brake pedal BP are monitored by those sensors. The pressure sensor Smc may be disposed in the hydraulic pressure circuit H1, or in both of the hydraulic pressure circuits. Furthermore, in order to achieve those controls including the anti-skid control or the like, the sensors SN such as wheel speed sensors, acceleration sensor or the like have been provided, so that the signals detected by them are fed to the electronic control unit ECU.

Hereinafter, explained is operation of the hydraulic brake apparatus having the hydraulic braking pressure generating apparatus as constituted above. At the outset, in the case where the pressure control device PC is normal, the switching valves NO1 and NO2 as shown in FIG. 2 are energized to be placed in their closed positions, so that the hydraulic pressure circuits H1 and H2 are shut off, and the hydraulic pressure discharged from the pressure source PG is supplied to the wheel brake cylinders WC1 and WC2 in response to operation of the brake pedal BP, on the basis of the value detected by the stroke sensor BS and the pressure sensor Smc. That is, the electric current fed to the first linear solenoid valves SV1 and SV3, and the second linear solenoid valves SV2 and SV4 will be controlled respectively, so that the wheel cylinder pressure detected by the pressure sensor Swc will be made equal to the desired wheel cylinder pressure. Consequently, the hydraulic pressure controlled by the pressure control device PC in response to operation of the brake pedal BP is supplied to the wheel brake cylinders WC1 and WC2. In this case, the second master piston MP2 is advanced only by a distance approximately equal to the port idle (first stroke d1), and will not be moved after the communication between the second master chamber C2 and the atmospheric pressure chamber C3 has been shut off, whereas only the first master piston MP1 will be advanced. In this case, as the first master chamber C1 and the pressure chamber C5 have been communicated with each other through the communication passage P7 (the communication grooves P71 in FIG. 3, or cut-out sections P72 in FIG. 4), if the braking operation force applied to the piston member AP of the stroke simulator AB is increased in response to operation of the brake pedal BP to exceed the mounting load of the compression spring E3, the compression spring E3 is compressed to provide the stroke of the first master piston MP1 in response to the braking operation force.

On the contrary, in the case where the pressure control device PC including the pressure source PG and the like comes to be abnormal, the switching valves NO1 and NO2 are de-energized (turned off) to be placed in their open positions, so that the hydraulic pressure circuits H1 and H2 are in their communicated states as shown in FIG. 2. At the same time, the first linear solenoid valves SV1 and SV3 and the second linear solenoid valves SV2 and SV4 are de-energized (turned off) to be placed in their closed positions, respectively, so that the hydraulic pressure will not be supplied from the pressure source PG to the wheel brake cylinders WC1 and WC2. In this state, therefore, when the brake pedal BP is depressed, to advance the second master piston MP2 by the second stroke (d2) or more from the initial position in response to operation of the brake pedal BP, its whole outer peripheral surface will contact the seal member S5, to block the communication between the first master chamber C1 and the pressure chamber C5 in the stroke simulator AB. Consequently, the first and second master pistons MP1 and MP2 will be advanced to compress the first and second master chambers C1 and C2, respectively, without the stroke simulator AB being operated, thereby to discharge the hydraulic pressure to the hydraulic pressure circuits H1 and H2 in response to operation of the brake pedal BP.

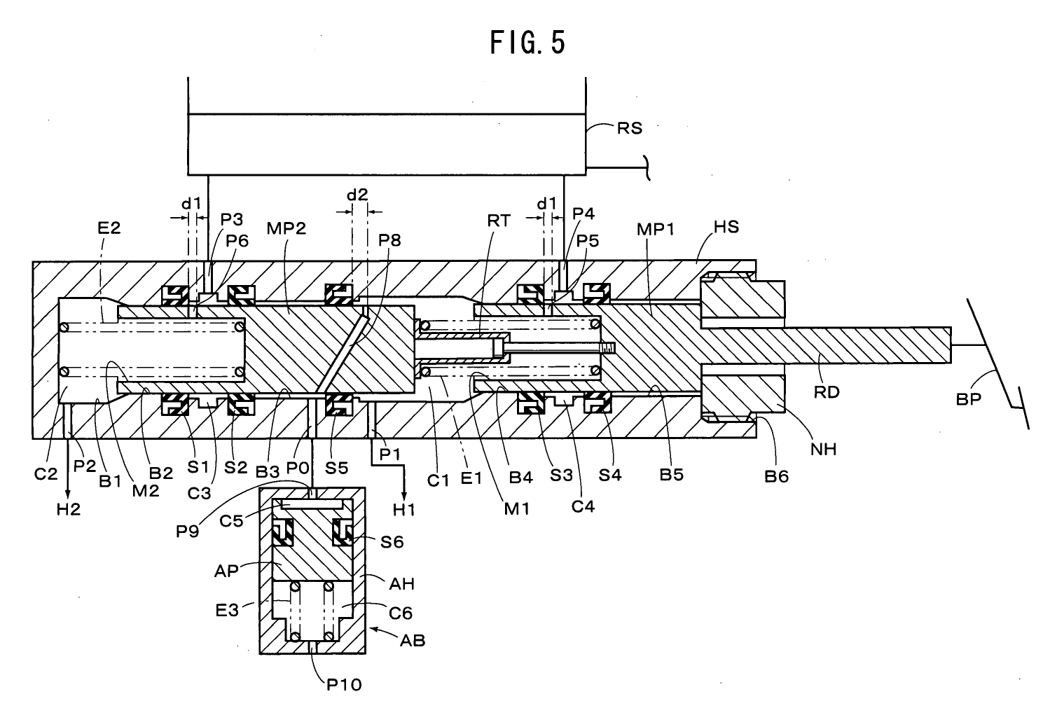

Next, another embodiment of the present invention is explained referring to FIG. 5, wherein structural elements equivalent to those described in FIG. 1 are designated by corresponding reference numerals. According to the present embodiment, as for the communication passage of the present invention, a communication hole P8 is formed to penetrate the second master piston MP2 in a direction crossing its longitudinal axis (i.e., offset radial direction). When the second master piston MP2 is placed in its initial position as shown in FIG. 5, the seal member S5 is in contact with the outer peripheral surface of the other part of the peripheral surface of the main body portion with the communication hole P8 formed on one part of it, to be opened at the front and rear sections of the seal member S5 along its longitudinal axis, so that the first master chamber C1 under the atmospheric pressure is communicated with the hydraulic pressure chamber C5 of the stroke simulator AB through the communication hole P8. And, when the second master piston MP2 is advanced from its initial position by the first stroke d1 (port idle) or more, the opening area of the port P6 is closed by the seal member S1, thereby to block the communication between the second master chamber C2 and the atmospheric pressure chamber C3. Likewise, when the first master piston MP1 is advanced from its initial position by the first stroke d1 (port idle) or more, the opening area of the port P5 is closed by the seal member S3, thereby to block the communication between the first master chamber C1 and the atmospheric pressure chamber C4. And, when the second master piston MP2 is advanced from its initial position by the second stroke d2 or more, the communication hole P8 is separated from the first master chamber C1 by the seal member S5, whereby the communication between the first master chamber C1 and the pressure chamber C5 is blocked.

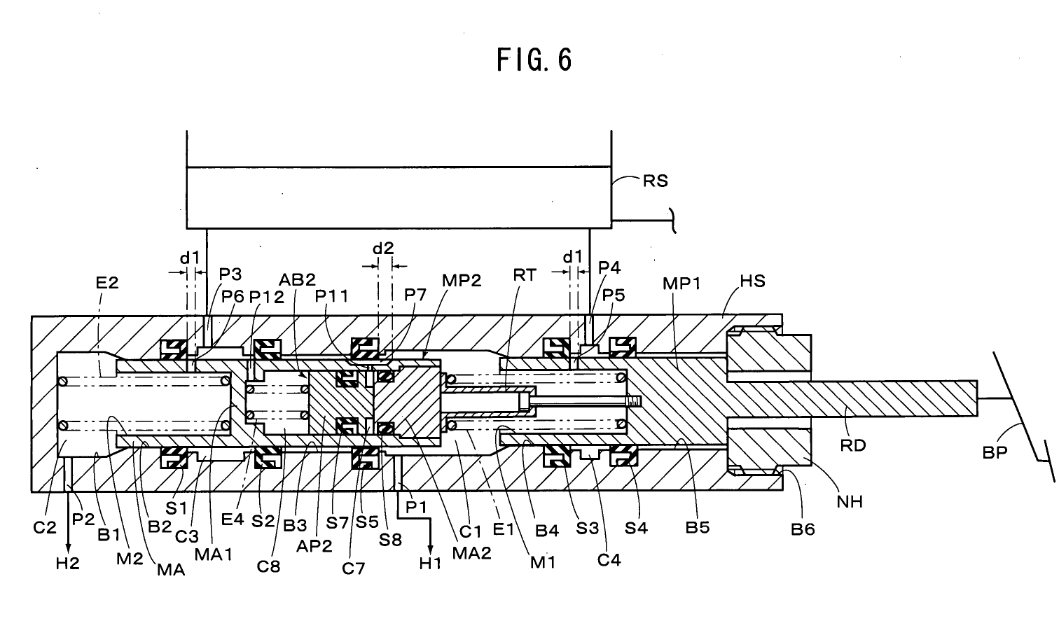

FIG. 6 shows a further embodiment of the present invention, wherein a stroke simulator AB2 is accommodated in the second master piston MP2, and wherein structural elements equivalent to those described in FIG. 1 are designated by corresponding reference numerals. According to the present embodiment, the stroke simulator AB2 includes a piston member AP2, which is fluid-tightly and slidably received in a cylindrical bore formed in the housing MA of the second master piston MP2 to be divided by a partition wall MA1 and opened rearward, through a seal member S7, and which is urged rearward by a compression spring E4. The rear end of the housing MA is sealed by a plug member MA2 through a seal member S8, so that a hydraulic pressure chamber C7 is defined between the plug member MA2 and the piston member AP2, and that an atmospheric pressure chamber C8 is defined in front of the piston member AP2. Furthermore, the same communication passage P7 as that shown in FIG. 1 is formed on a part of outer peripheral surface of the end portion of the housing MA, which passage may include the communication grooves P71 as shown in FIG. 3, the cut-out sections P72 as shown in FIG. 4, and the communication hole P8 as shown in FIG. 5. And, the housing MA is formed with a port P11 for communicating the communication passage P7 with the hydraulic pressure chamber C7, and formed with a port P12 for communicating the atmospheric pressure chamber C3 with the atmospheric pressure chamber C8.

Accordingly, when the second master piston MP2 is placed in its initial position as shown in FIG. 6, the seal member S5 is in contact with the outer peripheral surface of the portion with the communication passage P7 (or, the communication grooves P71 in FIG. 3, cut-out sections P72 in FIG. 4, communication hole P8 in FIG. 5) formed thereon, so that the first master chamber C1 under the atmospheric pressure is communicated with the hydraulic pressure chamber C7. And, when the second master piston MP2 is advanced from its initial position by the first stroke d1 (port idle) or more, the opening area of the port P6 is closed by the seal member S1, thereby to block the communication between the second master chamber C2 and the atmospheric pressure chamber C3. The atmospheric pressure chamber C8 is always communicated with the atmospheric pressure chamber C3, and therefore communicated with the reservoir RS. Likewise, when the first master piston MP1 is advanced from its initial position by the first stroke d1 (port idle) or more, the opening area of the port P5 is closed by the seal member S3, thereby to block the communication between the first master chamber C1 and the atmospheric pressure chamber C4.

With the first master piston MP1 being advanced, the piston member AP2 is pushed against the biasing force of the compression spring E4 to provide the stroke of the first master piston MP1. Thereafter, as the pressure chamber C7 will be communicated with the first master chamber C1 through the communication passage P7, the piston member AP2 or the like will be moved to act as the stroke simulator, until the second master piston MP2 will be advanced from its initial position by the predetermined distance (second stroke d2) to contact the seal member S5 at its whole outer peripheral surface. And, when the second master piston MP2 is advanced from its initial position by the second stroke d2 or more, the port P5 is separated from the first master chamber C1 by the seal member S5, whereby the communication between the first master chamber C1 and the pressure chamber C7 is blocked.

According to the present embodiment, therefore, in the case where the pressure control device PC as shown in FIG. 2 is normal, the switching valves NO1 and NO2 are energized to be placed in their closed positions, so that the second master piston MP2 is not advanced more than the first stroke d1, but only the first master piston MP1 is advanced, so that the piston member AP2 or the like will be moved to act as the stroke simulator. In the case where the pressure control device PC comes to be abnormal, the switching valves NO1 and NO2 are placed in their open positions, so that the hydraulic pressure circuits H1 and H2 are in their communicated states. Consequently, the first and second master pistons MP1 and MP2 are advanced almost equally, and when the second master piston MP2 is advanced from its initial position by the second stroke d2 or more, the communication between the first master chamber C1 and the pressure chamber C7 is blocked by the seal member S5, so that the piston member AP2 will not be moved, and the hydraulic pressure will be discharged to the hydraulic pressure circuits Hi and H2 in response to advancing operation of the first and second master pistons MP1 and MP2.

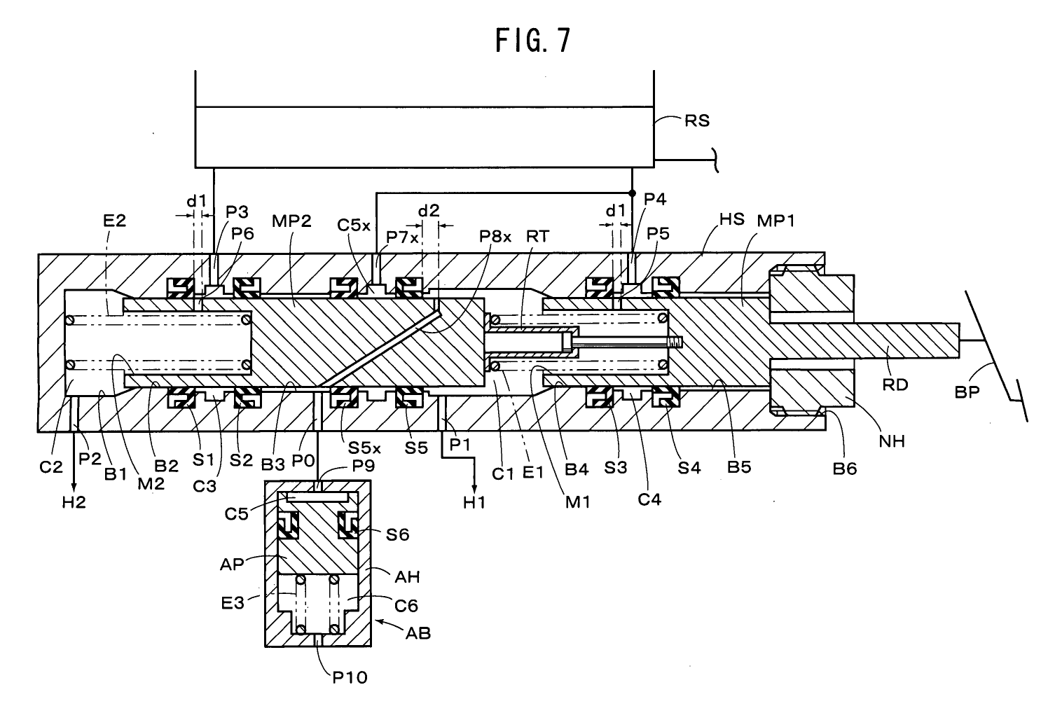

FIGS. 7-10 relate to the invention including the communication control device having a seal member disposed in the cylinder housing and applied with the hydraulic pressure in the first master pressure chamber when the first master pressure chamber is communicated with the stroke simulator, wherein structural elements equivalent to those described in FIGS. 1-6 are designated by corresponding reference numerals. Referring to FIG. 7, the housing HS is closed in its front end (left in FIG. 7) to be formed in a cylinder with a bottom, and formed with a cylinder bore having a recess B1, and a stepped bore of the small diameter bore B2, stepped large diameter bore B3, small diameter bore B4 and large diameter bore B5. At the rear end of the housing HS, there is formed the open end portion B6 with threaded grooves formed on its inner surface. On the inner wall of the cylinder bore, formed are annular grooves for holding annular seal members S1-S5 and S5x having a cup-like cross section, respectively. The atmospheric pressure chamber C3 is defined between the annular seal members S1 and S2, and the atmospheric pressure chamber C4 is defined between the annular seal members S3 and S4. In addition, an atmospheric pressure chamber C5x is defined between the annular seal members S5 and S5x. On the side wall of the housing HS, there are formed the ports P0 and P1 opening into the front section and the rear section of the seal members S5 and S5x in the large diameter bore B3, respectively, the port P2 opening into the second master chamber C2 in the recess B1, the port P3 opening into the atmospheric pressure chamber C3, the port P4 opening into the atmospheric pressure chamber C4, and a port P7x opening into the atmospheric pressure chamber C5x. The ports P3, P4 and P7x are communicated with the (atmospheric pressure) reservoir RS.

As for the first master piston MP1, there are formed at its front end the recess M1 opening forward, and formed at its rear end the rod RD extending backward. On the side wall of the first master piston MP1, there is formed the port P5 opening into the recess M1. The second master piston MP2 is formed with the recess M2 opening forward, and formed with a communication hole P8x in a direction crossing the longitudinal axis of the second master piston MP2 (i.e., offset radial direction). Furthermore, on the side wall of the second master piston MP2, there is formed the port P6 opening into the recess M2. When the second master piston MP2 is placed in its initial position, therefore, the seal members S5 and S5x are in contact with the outer peripheral surface of the portion of piston MP2 without the communication hole P8x being formed, as shown in FIG. 7, the communication hole P8x is formed to be opened at the front section and rear section of the seal members S5 and S5x along the longitudinal axis.

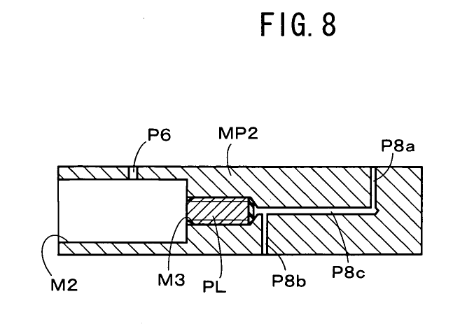

As shown in FIG. 7, the communication hole P8x is formed to be inclined by a certain angle against the longitudinal axis of the second master piston MP2, to provide the communication hole formed in the direction crossing the longitudinal axis according to the present invention. In contrast, it may be so constituted as shown in FIG. 8 that a pair of holes P8a and P8b are formed in a radial direction perpendicular to the longitudinal axis of the second master piston MP2, and a hole P8c is formed along the longitudinal axis for connecting the holes P8a and P8b, and closed by a plug member PL. With the holes P8a, P8b and P8c, therefore, the communication hole is formed substantially in the direction crossing the longitudinal axis, to act as the communication hole P8x as shown in FIG. 7. As shown in FIG. 8, the second master piston MP2 is formed with a recess M3 for the convenience in forming the hole P8c, and the plug member PL is fitted into the recess M3 to close the opening end of the hole P8c.

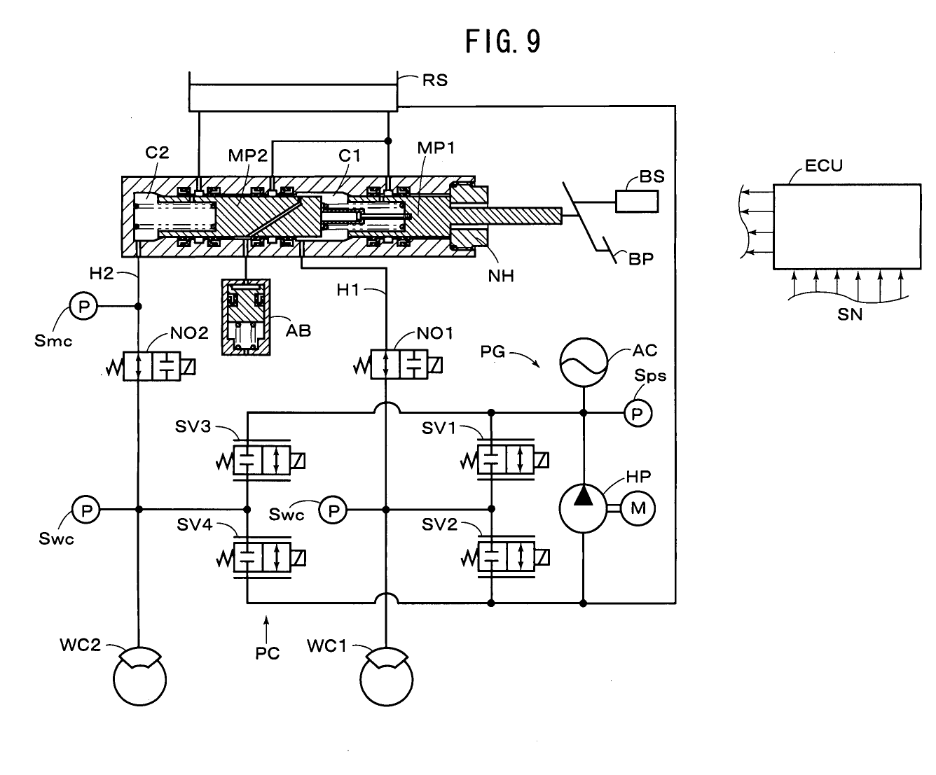

According to the present embodiment, the same stroke simulator AB as the one as shown in FIG. 1 is disposed to communicate its hydraulic pressure chamber C5 with the annular space between the seal members S2 and S5x through the ports P9 and P0. And, the parts of the master cylinder as shown in FIG. 7 are assembled in substantially the same manner as described before, so that the explanation is omitted herein. The first master chamber C1 and the second master chamber C2 are defined in front of the first master piston MP1 and second master piston MP2, respectively, in the housing HS, to be communicated with the wheel brake cylinder WC1 and WC2 as shown in FIG. 9, through the ports P1 and P2 via hydraulic pressure circuits H1 and H2, respectively. And, when the first and second master pistons MP1 and MP2 are placed in their initial positions as shown in FIG. 7, the first and second master chambers C1 and C2 are communicated with the atmospheric pressure chambers C4 and C3 through the ports P5 and P6, and finally communicated with the reservoir RS through the ports P4 and P3, respectively.

When the second master piston MP2 is placed in its initial position as shown in FIG. 7, the seal members S5 and S5x are in contact with the outer peripheral surface of the part of the main body portion without the communication hole P8x being formed therein, so that the first master chamber C1 under the atmospheric pressure is communicated with the hydraulic pressure chamber C5 of the stroke simulator AB through the communication hole P8x (and, the ports P0 and P9). And, when the second master piston MP2 is advanced from its initial position by the first stroke d1 (port idle) or more, the opening area of the port P6 is closed by the seal member S1, thereby to block the communication between the second master chamber C2 and the atmospheric pressure chamber C3. Likewise, when the first master piston MP1 is advanced from its initial position by the first stroke d1 (port idle) or more, the opening area of the port P5 is closed by the seal member S3, thereby to block the communication between the first master chamber C1 and the atmospheric pressure chamber C4.

With the first master piston MP1 being advanced, the piston member AP is pushed against the biasing force of the compression spring E3 to provide the stroke of the first master piston MP1. Thereafter, the pressure chamber C5 will be communicated with the first master chamber C1 through the communication hole P8x (and, the ports P0 and P9) to actuate the stroke simulator AB, until the second master piston MP2 will be advanced from its initial position by the predetermined distance (second stroke d2) to contact the seal member S5 at its whole outer peripheral surface including the communication hole P8x. And, when the second master piston MP2 is advanced from its initial position by the second stroke d2 or more, the communication hole P8x is separated from the first master chamber C1 by the seal member S5, whereby the communication between the first master chamber C1 and the pressure chamber C5 is blocked.

According to the present embodiment, therefore, the communication hole P8x and the seal member S5 constitute the communication control device according to the present invention. In the present embodiment, a clearance or longitudinal distance between the seal members S5 and S5x may be formed to be shorter than the distance as shown in FIG. 7. For example, it may be so constituted that the upper end of the communication hole P8x as shown in FIG. 7 shall pass the seal member S5x, until the second mater piston MP2 will be advanced to its full-stroke. Or, it may be so constituted that the lower end of the communication hole P8x as shown in FIG. 7 shall pass the seal member S2, after the upper end of the communication hole P8x passed the seal member S5x, whereby the longitudinal distance between the seal members S5 and S2 can be shortened comparing with that as shown in FIG. 7.

The hydraulic braking pressure generating apparatus according to the present embodiment is provided to constitute the hydraulic brake apparatus as shown in FIG. 9, in substantially the same manner as shown in FIG. 2, so that the explanation of it is omitted herein. And, the hydraulic brake apparatus operates in substantially the same manner as the embodiment as shown in FIG. 2. In the case where the pressure control device PC including the pressure source PG and the like comes to be abnormal, the switching valves NO1 and NO2 are de-energized (turned off) to be placed in their open positions, so that the hydraulic pressure circuits H1 and H2 are in their communicated states as shown in FIG. 9. At the same time, the first linear solenoid valves SV1 and SV3 and the second linear solenoid valves SV2 and SV4 are de-energized (turned off) to be placed in their closed positions, respectively, so that the hydraulic pressure will not be supplied from the pressure source PG to the wheel brake cylinders WC1 and WC2. In this state, therefore, when the brake pedal BP is depressed, to advance the second master piston MP2 by the second stroke (d2) or more from the initial position in response to operation of the brake pedal BP, its whole outer peripheral surface including the opening end of the communication hole P8x will contact the seal member S5, to block the communication between the first master chamber C1 and the pressure chamber C5 in the stroke simulator AB. Consequently, the first and second master pistons MP1 and MP2 will be advanced to compress the first and second master chambers C1 and C2, respectively, thereby to discharge the hydraulic pressure to the hydraulic pressure circuits H1 and H2 in response to operation of the brake pedal BP.

Furthermore, according to the present embodiment, it is so constituted that the seal member S5 is applied with the hydraulic pressure in the first master chamber C1, even in such a state that the first master chamber C1 is being communicated with the stroke simulator AB. Therefore, when the braking operation is performed by the vehicle driver to move the first master piston MP1, the hydraulic pressure is generated in the first master chamber C1, so that the hydraulic pressure is applied to the seal member S5. Therefore, even in the case where the pressure source PG or the like is normal, if the seal member S5 has been damaged in its sealing property, the vehicle driver can feel the damage of the seal member S5, because no reaction force is created in response to braking operation of the vehicle driver due to insufficiency of the sealing property.

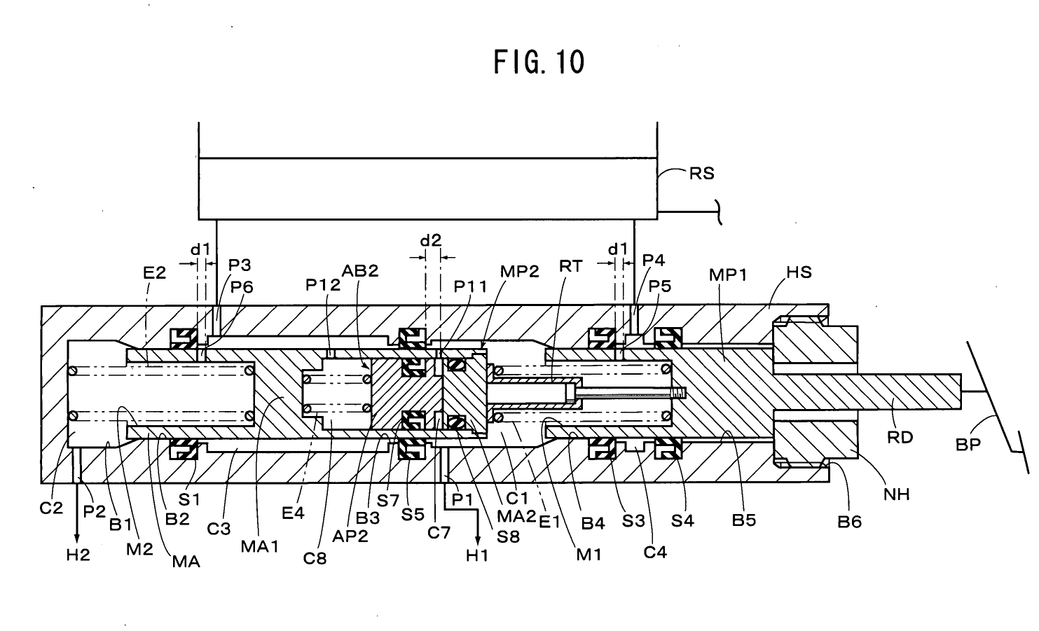

FIG. 10 shows a yet further embodiment of the present invention, wherein the stroke simulator AB2 is accommodated in the second master piston MP2, and wherein structural elements equivalent to those described in FIG. 7 are designated by corresponding reference numerals. And, comparing with the embodiment as shown in FIG. 6, the port P7 and seal member S2 are not provided in the present embodiment as shown in FIG. 10, and the port P11 is opened at a different position from the position in FIG. 6. According to the present embodiment, therefore, the stroke simulator AB2 includes the piston member AP2, which is fluid-tightly and slidably received through the seal member S7 in the cylindrical bore formed in the housing MA of the second master piston MP2 to be opened rearward, and which is urged rearward by the compression spring E4. The rear end of the housing MA is sealed by the plug member MA2 through the seal member S8, so that the hydraulic pressure chamber C7 is defined between the plug member MA2 and the piston member AP2, and that the atmospheric pressure chamber C8 is defined in front of the piston member AP2. Furthermore, the housing MA is formed with the port P11 for communicating the first master chamber C1 with the hydraulic pressure chamber C7, and formed with the port P12 for communicating the atmospheric pressure chamber C3 with the atmospheric pressure chamber C8.

Accordingly, when the second master piston MP2 is placed in its initial position as shown in FIG. 10, the seal member S5 is in contact with the outer peripheral surface of the portion without the port P11 being formed, so that the first master chamber C1 under the atmospheric pressure is communicated with the hydraulic pressure chamber C7 through the port P11. And, when the second master piston MP2 is advanced from its initial position by the first stroke d1 (port idle) or more, the opening area of the port P6 is closed by the seal member S1, thereby to block the communication between the second master chamber C2 and the atmospheric pressure chamber C3. The atmospheric pressure chamber C8 is always communicated with the atmospheric pressure chamber C3, and therefore communicated with the reservoir RS. Likewise, when the first master piston MP1 is advanced from its initial position by the first stroke d1 (port idle) or more, the opening area of the port P5 is closed by the seal member S3, thereby to block the communication between the first master chamber C1 and the atmospheric pressure chamber C4.

With the first master piston MP1 being advanced, the piston member AP2 is pushed against the biasing force of the compression spring E4 to provide the stroke of the first master piston MP1. Thereafter, as the pressure chamber C7 will be communicated with the first master chamber C1 through the port P11, the piston member AP2 or the like will be moved to act as the stroke simulator, until the second master piston MP2 will be advanced from its initial position by the predetermined distance (second stroke d2) to contact the seal member S5 at its whole outer peripheral surface including the port P11. And, when the second master piston MP2 is advanced from its initial position by the second stroke d2 or more, the port P11 is separated from the first master chamber C1 by the seal member S5, whereby the communication between the first master chamber C1 and the pressure chamber C7 is blocked.

According to the present embodiment, therefore, in the case where the pressure control device PC as shown in FIG. 9 is normal, the switching valves NO1 and NO2 are energized to be placed in their closed positions, so that the second master piston MP2 is not advanced more than the first stroke d1, but only the first master piston MP1 is advanced, so that the piston member AP2 or the like will be moved to act as the stroke simulator. In the case where the pressure control device PC comes to be abnormal, the switching valves NO1 and NO2 are placed in their open positions, so that the hydraulic pressure circuits H1 and H2 are in their communicated states. Consequently, the first and second master pistons MP1 and MP2 are advanced almost equally, and when the second master piston MP2 is advanced from its initial position by the second stroke d2 or more, the communication between the first master chamber C1 and the pressure chamber C7 is blocked by the seal member S5, so that the piston member AP2 will not be moved, and the hydraulic pressure will be discharged to the hydraulic pressure circuits H1 and H2 in response to advancing operation of the first and second master pistons MP1 and MP2. Furthermore, when the braking operation is performed by the vehicle driver to move the first master piston MP1, the hydraulic pressure is generated in the first master chamber C1, so that the hydraulic pressure is applied to the seal member S5. Therefore, even in the case where the pressure source PG or the like is normal, if the seal member S5 has been damaged in its sealing property, the vehicle driver can feel the damage of the seal member S5.

It should be apparent to one skilled in the art that the above-described embodiments are merely illustrative of but one of the many possible specific embodiments of the present invention. Numerous and various other arrangements can be readily devised by those skilled in the art without departing from the spirit and scope of the invention as defined in the following claims.

1. A hydraulic braking pressure generating apparatus for vehicles, comprising:
a first piston member slidably accommodated in a cylinder housing to be moved back and forth in response to operation of a manually operated braking member;
a second piston member slidably accommodated in said cylinder housing for defining a first master pressure chamber between said first piston member and said second piston member, and defining a second master pressure chamber between said second piston member and said cylinder housing;
a stroke simulator communicated with said first master pressure chamber for absorbing brake fluid of an amount determined in response to the hydraulic pressure discharged from said first master pressure chamber, to provide a stroke for said first piston member in response to braking operation force of said manually operated braking member;
communication control means for communicating said first master pressure chamber with said stroke simulator when said second piston member is placed in an initial position thereof, and blocking the communication between said first master pressure chamber and said stroke simulator, when said second piston member is advanced by a predetermined distance or more from the initial position thereof,
wherein said communication control means includes a seal member disposed in said cylinder housing, and a communication passage formed on a part of outer periphery of said second piston member, and wherein said communication control means communicates said first master pressure chamber with said stroke simulator through said communication passage, when said second piston member is placed in the initial position thereof, and said communication control means separates said communication passage from said first master pressure chamber by said seal member, when said second piston member is advanced from the initial position thereof by the predetermined distance or more, to block the communication between said first master pressure chamber and said stroke simulator.

2. A hydraulic braking pressure generating apparatus for vehicles as set forth in claim 1, wherein said communication passage includes a longitudinal communication groove formed around a part of the outer peripheral surface of said second piston member.

3. A hydraulic braking pressure generating apparatus for vehicles as set forth in claim 1, wherein said communication passage includes a longitudinal cut-out section formed around a part of the outer peripheral surface of said second piston member.

4. A hydraulic braking pressure generating apparatus for vehicles as set forth in claim 1, wherein said communication passage includes a communication hole formed to penetrate said second piston member in a direction crossing a longitudinal axis thereof.

5. A hydraulic braking pressure generating apparatus for vehicles as set forth in claim 1, wherein said stroke simulator is accommodated in said second piston member.

6. A hydraulic braking pressure generating apparatus for vehicles as set forth in claim 5, wherein said communication passage includes a longitudinal communication groove formed around a part of the outer peripheral surface of said second piston member.

7. A hydraulic braking pressure generating apparatus for vehicles as set forth in claim 5, wherein said communication passage includes a longitudinal cut-out formed around a part of the outer peripheral surface of said second piston member.

8. A hydraulic braking pressure generating apparatus for vehicles as set forth in claim 5, wherein said communication passage includes a communication hole formed to penetrate said second piston member in a direction crossing a longitudinal axis thereof.

9. A hydraulic braking pressure generating apparatus for vehicles, comprising:
a first piston member slidably accommodated in a cylinder housing to be moved back and forth in response to operation of a manually operated braking member;
a second piston member slidably accommodated in said cylinder housing for defining a first master pressure chamber between said first piston member and said second piston member, and defining a second master pressure chamber between said second piston member and said cylinder housing;
a stroke simulator communicated with said first master pressure chamber for absorbing brake fluid of an amount determined in response to the hydraulic pressure discharged from said first master pressure chamber, to provide a stroke for said first piston member in response to braking operation force of said manually operated braking member;
communication control means having a seal member disposed in said cylinder housing and applied with the hydraulic pressure in said first master pressure chamber when said first master pressure chamber is communicated with said stroke simulator, said communication control means communicating said first master pressure chamber with said stroke simulator when said second piston member is placed in an initial position thereof, and blocking the communication between said first master pressure chamber and said stroke simulator, by said seal member, when said second piston member is advanced by a predetermined distance or more from the initial position thereof,
wherein said communication control means includes a communication hole formed to penetrate said second piston member in a direction crossing a longitudinal axis thereof, and wherein said communication control means communicates said first master pressure chamber with said stroke simulator through said communication hole, when said second piston member is placed in the initial position thereof, and said communication control means separates said communication hole from said first master pressure chamber by said seal member, when said second piston member is advanced from the initial position thereof by the predetermined distance or more, to block the communication between said first master pressure chamber and said stroke simulator.

10. A hydraulic braking pressure generating apparatus for vehicles as set forth in claim 9, wherein said stroke simulator is accommodated in said second piston member.
